(19) United States
(12) Patent Application Publication
(10) Pub. No.: US 2025/0308809 A1
(43) Pub. Date: Oct. 2, 2025

(54) ELECTROLYTIC CAPACITOR

(71) Applicant: Panasonic Intellectual Property Management Co., Ltd., Osaka (JP)

(72) Inventors: MOMO KUSAKABE, Kyoto (JP); SAORI UEDA, Osaka (JP)

(21) Appl. No.: 19/235,189

(22) Filed: Jun. 11, 2025

Related U.S. Application Data
(63) Continuation of application No. PCT/JP2023/046241, filed on Dec. 22, 2023.

(30) Foreign Application Priority Data
Dec. 27, 2022 (JP) 2022-210806

(51) Int. Cl. H01G 9/15; H01G 9/012; H01G 9/10

(52) U.S. Cl. CPC H01G 9/15; H01G 9/012; H01G 9/10

(57) ABSTRACT

An electrolytic capacitor includes: a capacitor element including an anode part and a cathode part; an exterior body sealing the capacitor element; a metal foil electrically connected to the cathode part; a first external electrode electrically connected to the metal foil; and a conductive adhesive layer. The metal foil includes a through-hole passing through the metal foil in a thickness direction. The conductive adhesive layer includes a first layer interposed between the cathode part and a first principal surface of the metal foil, and a second layer filled in the through-hole. The first layer and the second layer are integrated with each other. The metal foil includes a first end surface exposed from the exterior body. The first end surface is electrically connected to the first external electrode.

### BACKGROUND

### 1. Technical Field

The present disclosure relates to an electrolytic capacitor.

### 2. Description of the Related Art

An electrolytic capacitor includes a capacitor element, an exterior body that seals the capacitor element, and an external electrode electrically connected with the capacitor element. The capacitor element includes an anode part and a cathode part. The cathode part is in contact with metal foil with a conductive adhesive layer interposed therebetween. The metal foil has an end surface exposed from the exterior body, and the end surface is electrically connected to the external electrode close to the cathode.

International Publication WO 2018/074408 discloses “A solid electrolytic capacitor comprising: a plurality of units stacked, the units each including a valve metal substrate having a porous layer on a surface thereof, a dielectric layer formed on a surface of the porous layer, and a solid electrolyte layer provided on the dielectric layer. A conductor layer exists between the corresponding laminated units, and at least one of the conductor layers includes metal foil. The units and the conductor layer are sealed with an outer packaging resin. The valve metal substrate has an end surface close to an anode part, the end surface being directly connected to an anode external electrode formed on a surface of the outer packaging resin at one end surface of the solid electrolytic capacitor. The metal foil is directly connected to a cathode external electrode formed on a surface of the outer packaging resin at another end surface of the solid electrolytic capacitor.”

International Publication WO 2018/074408 also discloses that “the conductor layer including the metal foil includes a carbon layer provided on the solid electrolyte layer, a conductive adhesive layer provided on the carbon layer, and a metal foil provided on the conductive adhesive layer”.

### SUMMARY

An aspect of the present disclosure relates to an electrolytic capacitor including: a capacitor element including an anode part and a cathode part; an exterior body sealing the capacitor element; a metal foil electrically connected to the cathode part; a first external electrode electrically connected to the metal foil; and a conductive adhesive layer. The metal foil includes a through-hole passing through the metal foil in a thickness direction. The conductive adhesive layer includes a first layer and a second layer, the first layer being disposed between the cathode part and a first principal surface of the metal foil, the second layer being filled in the through-hole. The first layer and the second layer are integrated with each other. The metal foil includes a first end surface exposed from the exterior body, and the first end surface is electrically connected to the first external electrode.

The present disclosure enables suppressing deterioration in reliability of an electrolytic capacitor.

Although novel features of the present invention are set forth in the scope of claims appended, the present invention will be better understood by detailed description below with the drawings, taken in conjunction with other objects and features of the present invention, both as to construction and content.

### BRIEF DESCRIPTION OF THE DRAWINGS

FIG. 1 is a sectional view schematically illustrating an example of an electrolytic capacitor according to one exemplary embodiment of the present disclosure;

FIG. 2 is an enlarged schematic sectional view illustrating a main part of the electrolytic capacitor illustrated in FIG. 1, the main part being a vicinity of a metal foil disposed between capacitor elements adjacent to each other in an element stack;

FIG. 3 is an enlarged schematic sectional view illustrating a main part of the electrolytic capacitor illustrated in FIG. 1, the main part being a vicinity of a metal foil disposed at one end part of the element stack;

FIG. 4 is a top view schematically illustrating an example of a metal foil including one through-hole with a cross section in a circular shape;

FIG. 5 is a top view schematically illustrating an example of a metal foil including two through-holes each with a cross section in a circular shape;

FIG. 6 is a top view schematically illustrating an example of a metal foil including five through-holes each with a cross section in a circular shape;

FIG. 7 is a top view schematically illustrating an example of a metal foil including three through-holes each with a cross section in a linear shape;

FIG. 8 is a top view schematically illustrating an example of a metal foil including five through-holes each with a cross section in a linear shape;

FIG. 9 is a top view schematically illustrating an example of a metal foil including seven through-holes each with a cross section in a linear shape;

FIG. 10 is a top view schematically illustrating an example of a metal foil including nine through-holes each with a cross section in a linear shape; and

FIG. 11 is a top view schematically illustrating an example of a metal foil including eleven through-holes each with a cross section in a linear shape.

### DETAILED DESCRIPTION OF EMBODIMENT

Prior to description of an exemplary embodiment, a problem in the related art will be briefly described.

Adhesive strength between the metal foil and the capacitor element (cathode part) with the conductive adhesive layer disposed therebetween is low. Thus, peeling between the metal foil and the capacitor element (referred to below also as “lamination peeling”) occurs to cause contact resistance to be likely to increase. Meanwhile, when the capacitor element is sealed, displacement between the capacitor element and the metal foil (referred to below also as “lamination displacement”) is likely to occur. As a result, reliability of the electrolytic capacitor deteriorates.

An exemplary embodiment of the present disclosure will be described below with reference to examples, but the present disclosure is not limited to the examples to be described below. Although the description below may show specific numerical values and materials as examples, other numerical values and materials may be used as long as effect of the present disclosure can be achieved. Description, “numerical value A to numerical value B”, herein includes numerical value A and numerical value B, and can be read as “between numerical value A and numerical value B inclusive”. When the description below shows lower limits and upper limits of numerical values related to specific physical properties, conditions, or the like, as examples, any of the lower limits shown and any of the upper limits shown can be optionally combined unless the lower limit is equal to or more than the upper limit. When a plurality of materials is shown as examples, one kind of material may be selected among the materials and used alone, or two or more kinds of material of the materials may be used in combination.

The present disclosure also includes a combination of matters recited in two or more claims optionally selected from a plurality of claims recited in the scope of claims appended. That is, the matters recited in two or more claims optionally selected from the plurality of claims recited in the scope of claims appended can be combined as long as no technical contradiction arises.

An electrolytic capacitor according to an exemplary embodiment of the present disclosure includes: a capacitor element including an anode part and a cathode part; an exterior body sealing the capacitor element; a metal foil electrically connected to the cathode part; a first external electrode electrically connected to the metal foil; and a conductive adhesive layer. The metal foil includes a first end surface exposed from the exterior body, and the first end surface is electrically connected to the first external electrode. The metal foil includes a through-hole passing through the metal foil in a thickness direction. The conductive adhesive layer includes a first layer disposed between the cathode part and a principal surface of the metal foil, and a second layer filled in the through-hole. The first layer and the second layer are integrated with each other. The electrolytic capacitor may include one capacitor element or a plurality of capacitor elements. The first layer is formed on the principal surface of the metal foil and the second layer filled in the through-hole.

Adhesion effect and anchor effect by the second layer filled in the through-hole are combined to improve adhesion strength between the adhesive layer (first layer) and not only the metal foil but also the cathode part. This improvement suppresses deterioration in adhesive strength between the metal foil and the cathode part. Thus, increase in contact resistance, lamination peeling, and lamination displacement are suppressed. Hence, deterioration in reliability of the electrolytic capacitor due to the lamination peeling and the lamination displacement can be suppressed. The deterioration in reliability includes deterioration in performance, increase in variation in performance, and the like.

Although the second layer is desirably filled in the whole of the through-hole, the through-hole may partially include a part (gap) not filled with the second layer as long as the effect of the second layer is not impaired. A filling ratio of the second layer in the through-hole may be 55% or more, or 75% or more. The filling ratio of the second layer in the through-hole is a ratio of an area of a region occupied by the second layer to an area of a region occupied by the through-hole in a cross section in the thickness direction of the metal foil (cross section having the through-hole). That is, the filling ratio is acquired by “(S1/S0)×100” where S0 is the area of the region occupied by the through-hole and S1 is the area of the region occupied by the second layer, in the cross section. When each of a plurality of through-holes is filled with the second layer, a filling ratio of the second layer is desirably 90% or more in 60% or more (preferably 80% or more) of a total of the through-holes.

The electrolytic capacitor may include an element stack including a plurality of capacitor elements stacked on each other. In this configuration, the metal foil is disposed on at least one of the plurality of capacitor elements. The metal foil in this configuration is preferably disposed between the capacitor elements adjacent to each other. That is, the capacitor elements adjacent to each other preferably share one metal foil. In this configuration, the first layer is formed on each of both principal surfaces of the metal foil. That is, the first layer includes a 1A-th layer disposed between the cathode part of one of the capacitor elements adjacent to each other and one principal surface of the metal foil, and a 1B-th layer disposed between the cathode part of the other of the capacitor elements adjacent to each other and the other principal surface of the metal foil. The 1A-th layer and the 1B-th layer are integrated with the second layer.

When the metal foil is disposed between the capacitor elements adjacent to each other, a region including the 1A-th layer, the second layer, and the 1B-th layer is formed between the capacitor elements adjacent to each other. The 1A-th layer and the 1B-th layer are integrated with the second layer interposed therebetween. Hence, adhesive strength between the capacitor elements is further improved. The anchor effect acquired by the second layer is efficiently exerted on both the 1A-th layer and the 1B-th layer.

When the metal foil is disposed between the capacitor elements adjacent to each other, gas generated in the element stack is discharged through the through-hole of the metal foil. Hence, swelling in a stacking direction of the electrolytic capacitor due to increase in the amount of gas generation can be suppressed, and thus deterioration in performance (e.g., increase in ESR) and variation in the performance due to the swelling can be suppressed. The gas is particularly likely to move through a region (gap) not filled with the second layer in the through-hole. The gas is likely to be generated when the electrolytic capacitor is exposed to a high temperature by heating in curing treatment, reflow treatment, or the like, during formation of the conductive adhesive layer.

### (Through-Hole)

The metal foil includes one through-hole or a plurality of through-holes passing through the metal foil in a thickness direction. The number of the through-holes ranges from 1 to 500, inclusive, for example. A maximum diameter of the through-hole ranges from 0.01 mm to 2 mm, inclusive, for example. An area of the through-hole in cross section ranges from 78 μm² to 3.14 mm², inclusive, for example. The plurality of through-holes may be regularly provided. The plurality of through-holes may be arranged in a lattice pattern (e.g., a zigzag lattice pattern or a square lattice pattern).

From the viewpoints of improvement in adhesive strength by formation of the second layer, securing of an adhesive region with the cathode part using the first layer, securing of strength of the metal foil, and the like, when the metal foil is viewed in the normal direction of the principal surface of the metal foil, a proportion of an area of the through-hole in the metal foil (region to be brought into contact with the cathode part) ranges preferably from 0.04% to 15%, inclusive, and more preferably from 0.1% to 10%, inclusive. The region to be brought into contact with the cathode part can also be said to be a region where the first layer is formed. When the plurality of through-holes are provided, the area of the through-hole means a total of areas of the plurality of through-holes.

When a proportion of the area of the through hole is 0.04% or more (or 0.1% or more), the effect of the second layer is likely to be obtained. When a proportion of the area of the through holes is 15% or less (or 10% or less), conductivity by the metal foil is sufficiently secured.

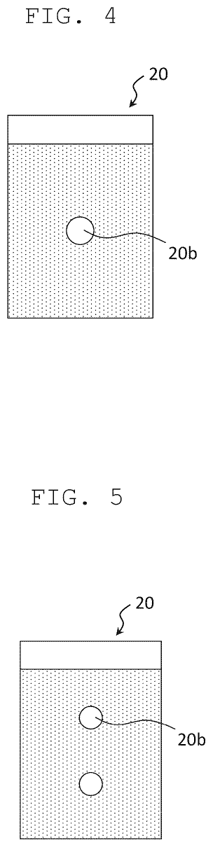

When the metal foil is viewed in the normal direction of the principal surface, a shape of the through-hole may be a circular shape, an elliptical shape, a polygonal shape, or a linear shape. The through-hole may be formed by punching depending on its shape. The through-hole in a linear shape has an elongated width formed by using a cutter knife or the like. The linear shape may be linear or curved. Examples of the polygonal shape include a triangular shape and a quadrangular shape. Examples of the metal foil having a through-hole include metal foil 20 including through-hole 20b illustrated in FIGS. 4 to 11. FIGS. 4 to 11 each show a shaded part that is a region to be brought into contact with the cathode part.

Depending on a method for forming the through-hole, roughness of the principal surface of the metal foil may be increased. For example, when a through-hole in a linear shape is formed by a cutter knife or the like, a protrusion may be formed on a peripheral edge part of the through-hole. Surface roughness Sa of the principal surface of the metal foil having the through-hole ranges from 10 μm to 200 μm, inclusive, for example. The term, “surface roughness Sa”, is one of three-dimensional surface property parameters defined in JIS B 0681-2:2018, and represents an arithmetic mean height.

### (Metal Foil)

The metal foil preferably contains aluminum, an aluminum alloy, copper, or a copper alloy from the viewpoints of ease of formation of the through-hole, strength, conductivity, and the like. The principal surface of the metal foil may be roughened by etching treatment or the like. The metal foil may include a coating layer on the principal surface. The coating layer may be formed on one principal surface of the metal foil, or may be formed on both principal surfaces. The coating layer includes a material (such as metal, a metal compound, or non-metal) different from that of the metal foil, for example.

Examples of material constituting the coating layer include a metal (titanium, nickel, or the like), a metal compound (nitrides, carbides, carbonitrides, oxides, and the like) such as a titanium compound, and a carbonaceous material. A metal oxide may be formed by an anodizing treatment. The coating layer may contain one kind or two or more kinds of these materials. The coating layer may have a single-layer structure or a multilayer structure.

The coating layer preferably includes at least one layer selected from the group consisting of a titanium layer, a nickel layer, a titanium nitride layer, a titanium carbide layer, a titanium carbonitride layer, a titanium oxide layer, and a carbon layer. This coating layer is likely to not only suppress deterioration in performance (e.g., increase in ESR), but also reduce variation in the performance.

The coating layer may be formed by a gas phase method, a firing method, or the like depending on its material. The material constituting the coating layer is directly fixed to the metal foil, and high conductivity is obtained. Examples of the gas phase method include vapor deposition (vacuum vapor deposition, electron beam vapor deposition, arc plasma vapor deposition, and the like), sputtering, and CVD.

A thickness of the metal foil may range from 0.1 μm to 100 μm, inclusive, or from 1 μm to 50 μm, inclusive. A thickness of the coating layer may range from 0.5 μm to 10 μm, inclusive, or from 1 μm to 5 μm, inclusive, per one principal surface of the metal foil.

### (Conductive Adhesive Layer)

The conductive adhesive layer preferably contains conductive particles and a resin (binder resin). The conductive particles preferably contain at least one kind selected from the group consisting of carbon particles and metal particles. Examples of the metal particles include silver particles and copper particles. The resin may include at least one of a thermoplastic resin and a cured product of a curable resin.

The conductive adhesive layer is formed by using a conductive adhesive that contains conductive particles and a resin material of at least one of a thermoplastic resin and a curable resin, for example. Examples of the resin material used for the conductive adhesive include an epoxy resin, an acrylic resin, a polyimide resin, a polyamide resin, a polyurethane resin, a polyester resin, a fluororesin, a vinyl resin, a polyolefin resin, a phenoxy resin, and a rubber-like material. As the epoxy resin, a bisphenol F type epoxy resin, a bisphenol A type epoxy resin, or a mixture thereof can be used. The epoxy resin may contain a polyfunctional epoxy resin. As the polyfunctional epoxy resin, a tetraphenylolethane resin can be used. The conductive adhesive may contain other materials such as a curing agent and a polymerization initiator. The conductive adhesive may contain a solvent.

The conductive adhesive layer may be formed by: applying a conductive adhesive to one principal surface (region to be brought into contact with the cathode part) of the metal foil; disposing a capacitor element (cathode part) on the conductive adhesive; and then filling a through-hole from an opening of the through-hole in the other principal surface of the metal foil with the conductive adhesive, for example. After that, when the capacitor element (cathode part) is separately disposed also on the other principal surface of the metal foil, a conductive adhesive may be further applied onto the conductive adhesive filled on the other principal surface and in the through-hole of the metal foil, and the capacitor element (cathode part) may be disposed on the conductive adhesive.

Alternatively, the conductive adhesive may be applied to the cathode part on one principal surface of the capacitor element, and the metal foil may be disposed on the cathode part. Then, the conductive adhesive may be applied to the cathode part on the other principal surface of the capacitor element, and another metal foil may be disposed on the cathode part. Then, a load may be applied to the capacitor element from above the metal foil to allow the conductive adhesive applied to the cathode part to partially enter the through-hole. In this way, the conductive adhesive layer may be formed.

Hereinafter, the electrolytic capacitor will be described in detail.

The capacitor element includes an anode part and a cathode part. The anode part is an anode body including a first part including one end (referred to also as a first end part) and a second part including the other end (referred to also as a second end part) opposite to the one end, for example. The cathode part is formed in the second part of the anode body. The anode body includes a dielectric layer on at least a surface of the second part.

### (Anode Body)

The anode body may contain a valve metal, an alloy containing a valve metal, and a compound (such as an intermetallic compound) containing a valve metal, for example. These materials may be used singly or in combination of two or more kinds thereof. Examples of the valve metal include aluminum, tantalum, niobium, and titanium. The anode body may be foil (anode foil) of a valve metal, an alloy containing a valve metal, or a compound containing a valve metal, or may be a molded body (porous molded body) of particles of a valve metal, an alloy containing a valve metal, or a compound containing a valve metal, or a sintered body (porous sintered body) thereof.

When the anode foil is used as the anode body, a porous part is usually formed in a surface of at least the second part of the anode foil to increase a surface area. The anode foil described above includes a core part and a porous part formed in a surface of the core part. The porous part is formed by forming unevenness in the surface of the anode foil, for example. The anode foil including the porous part may be formed by roughening the surface of at least the second part of the anode foil by etching (such as electrolytic etching) or the like, for example. Roughening treatment such as etching treatment can be performed after a predetermined masking member is disposed on a surface of the first part. Alternatively, the roughening treatment can be performed on the entire surface of the anode foil by the etching treatment or the like. The former enables obtaining an anode foil including no porous part in the surface of the first part and a porous part in the surface of the second part. The latter allows the porous part to be formed not only in the surface of the second part but also in the surface of the first part. As the etching treatment, a known method may be used, and examples of the known method include electrolytic etching. The masking member is not particularly limited, and may be a conductor containing a conductive material and is preferably an insulator such as resin. The masking member is removed before the solid electrolyte layer is formed.

When the roughening treatment is performed on the entire surface of the anode foil, the porous part is provided in the surface of the first part. This configuration may allow the porous part formed in the first part to be previously at least partially removed or compressed to crush pores of the porous part from the viewpoint of suppressing entry of air into the solid electrolytic capacitor through a contact part between the porous part and the exterior body. Hence, deterioration in reliability of the electrolytic capacitor due to intrusion of air can be suppressed.

When a plurality of capacitor elements are stacked, the first end part of the anode body of each of the capacitor elements may be bundled and connected to a lead to be electrically connected to an external electrode. Alternatively, end surfaces of the plurality of first end parts may be exposed from an outer surface of the exterior body without being bundled, and electrically connected to the external electrode.

The outer surface of the exterior body forms an outer shape of the exterior body. For example, when a sealed product in which a capacitor element is sealed with an exterior body together with a substrate has the shape of a rectangular parallelepiped or a cube, one surface (e.g., a bottom surface) may correspond to a surface of the substrate, and the remaining five surfaces (such as a side surface and a top surface) other than the surface of the substrate may correspond to the outer surface of the exterior body.

### (Dielectric Layer)

The dielectric layer is formed by anodizing the valve metal in the surface of at least the second part of the anode body by an anodizing treatment or the like. The dielectric layer contains an oxide of the valve metal. For example, when aluminum is used as the valve metal, the dielectric layer contains aluminum oxide. The dielectric layer is formed at least along the surface of the second part (including an inner wall surface of a pore of the porous part) where the porous part is formed. Besides this, a method for forming the dielectric layer is only required to form an insulating layer functioning as a dielectric material on the surface of the second part. The dielectric layer may also be formed on the surface of the first part (such as the porous part in the surface of the first part).

The anodizing treatment may be performed by immersing the anode body in an anodizing liquid to impregnate the surface of the anode body with the anodizing liquid, and applying a voltage between the anode body as an anode and a cathode immersed in the anodizing liquid, for example. When the porous part is provided in the surface of the anode body, the dielectric layer is formed along an uneven shape of the surface of the porous part.

### (Cathode Part)

The cathode part is formed on the second part of the anode body including the dielectric layer. The cathode part may be provided covering a surface of a separation layer close to the second part.

The cathode part may include a solid electrolyte layer covering at least a part of the dielectric layer, and a cathode lead-out layer covering at least a part of the solid electrolyte layer. This configuration causes the metal foil to be brought into contact with the cathode lead-out layer using a conductive adhesive. That is, the conductive adhesive layer is interposed between the cathode lead-out layer and the metal foil. The cathode part is formed by forming the solid electrolyte covering at least a part of the dielectric layer and forming the cathode lead-out layer covering at least a part of the solid electrolyte layer. When the cathode part is formed on a part of the anode body including the dielectric layer, a capacitor element is obtained.

### (Solid Electrolyte Layer)

The solid electrolyte layer contains a conductive polymer (such as a conjugated polymer, or a dopant), for example. As the conjugated polymer, a π-conjugated polymer (polypyrrole, polythiophene, polyaniline, derivatives thereof, and the like) may be used, for example. For example, the polythiophene derivative includes poly (3,4-ethylenedioxythiophene) (PEDOT) and the like. As the dopant, polystyrene sulfonic acid (PSS) or the like may be used, and naphthalene sulfonic acid, toluene sulfonic acid or the like may be used. The solid electrolyte layer can be formed by polymerizing a precursor of a conjugated polymer (such as a monomer or an oligomer) and a dopant (such as naphthalenesulfonic acid or toluenesulfonic acid) on the dielectric layer using at least one of chemical polymerization and electrolytic polymerization, for example. Alternatively, the solid electrolyte layer may be formed by attaching a solution in which the conjugated polymer and the dopant are dissolved, or a dispersing liquid in which the conjugated polymer and the dopant are dispersed, to the dielectric layer and drying the solution or the dispersing liquid. Examples of the dispersion medium (solvent) include water, an organic solvent, and a mixture thereof. The solid electrolyte layer may contain a manganese compound.

### (Cathode Lead-Out Layer)

The cathode lead-out layer may include a layer (referred to also as a carbon layer) containing conductive carbon and covering at least a part of the solid electrolyte layer. This configuration causes the metal foil to be brought into contact with the carbon layer using a conductive adhesive. That is, the conductive adhesive layer is interposed between the carbon layer and the metal foil. Examples of the conductive carbon contained in the carbon layer include graphite (such as artificial graphite or natural graphite).

The cathode lead-out layer may further include a metal-containing layer covering at least a part of the carbon layer. This configuration causes the metal foil to be brought into contact with the metal-containing layer. Between the metal-containing layer and the metal foil, a conductive adhesive layer may be further interposed. The metal-containing layer contains metal particles and a resin, for example. Examples of the metal particles include silver particles. The resin (binder resin) used for forming the metal-containing layer may be a thermoplastic resin, and is preferably a thermosetting resin such as an imide-based resin or an epoxy resin.

### (Separation Layer)

To electrically separate the anode part and the cathode part, a separation layer that is insulative may be provided. The separation layer is formed before the cathode part is formed. The separation layer may be provided close to the cathode part while covering at least a part of the surface of the first part. From the viewpoint of suppressing entry of air into the solid electrolytic capacitor, the separation layer may be in contact with the first part and the exterior body. The separation layer may be disposed on the first part with the dielectric layer interposed therebetween. The separation layer described above is provided after formation of the dielectric layer. Besides this configuration, the dielectric layer may be provided before the formation of the dielectric layer as necessary.

The separation layer contains resin, for example, and can use materials exemplified for the exterior body described later. The dielectric layer formed in the porous part of the first part may be compressed and densified to provide insulation.

The separation layer may be provided by bonding an insulation member in the shape of a sheet (resin tape or the like) to the first part, for example. When anode foil having a surface with a porous part is used, the insulation member may be brought into contact with the first part after the porous part of the first part is at least partially removed or compressed to flatten the first part. The insulation member in the shape of a sheet preferably include an adhesion layer on a surface to be bonded to the first part.

The insulation member in contact with the first part may be formed by causing the first part to be at least partially coated or impregnated with a liquid resin. In a method using the liquid resin, the insulation member may be formed filling unevenness of at least a surface layer of the porous part of the first part. This method allows the liquid resin to easily enter a recess in the surface layer of the porous part, thereby enabling the insulation member to be easily formed also in the recess. In this configuration, the porous part of the surface layer of the anode body is protected by the insulation member so that collapse of the porous part of the anode body is suppressed when the end part of the anode body is partially removed together with the exterior body to form the outer surface of the exterior body, and the end surface of the anode body is exposed from the outer surface of the exterior body. Since the surface layer of the porous part of the anode body and the insulation member are firmly in contact with each other, peeling of the insulation member from the surface of the porous part of the anode body is suppressed when the end part of the anode body is partially removed together with the exterior body.

As the liquid resin, a curable resin composition exemplified for the exterior body described later may be used, or a solution obtained by dissolving a resin in a solvent may be used, for example. Alternatively, an insulation member in the shape of a sheet coated or impregnated with the liquid resin may be used.

### (Substrate)

The electrolytic capacitor may include a substrate that supports one capacitor element or a stacked body including a plurality of capacitor elements. The substrate is an insulating substrate, for example. The substrate may be a metal substrate or a printed circuit board provided with a wiring pattern when the first external electrode and a second external electrode can be electrically separated from each other.

When the substrate is an insulating substrate, one capacitor element or a stacked body including a plurality of capacitor elements may be mounted on the substrate using an adhesive (such as an epoxy-based adhesive).

When the substrate is a metal substrate or the like, metal foil may be disposed between the substrate and the cathode part of one capacitor element, or metal foil may be disposed between the substrate and the cathode part of the capacitor element closest to the substrate in the element stack. In this configuration, the metal foil is bonded to the cathode part and the substrate by using a conductive adhesive. Thus, the conductive adhesive layer is formed not only between the metal foil and the cathode part but also between the metal foil and the substrate. That is, the conductive adhesive layer includes a first layer disposed between the cathode part and the principal surface of the metal foil that is close to the cathode part, a third layer disposed between the substrate and the principal surface of the metal foil that is close to the substrate, and a second layer filled in the through-hole of the metal foil, which is integrally formed with the first layer and the third layer. When the second layer is provided, adhesive strength between the cathode part and the metal foil as well as adhesive strength between the substrate and the metal foil is improved.

Examples of the insulating substrate include a glass epoxy substrate, a paper phenol substrate, a glass polyimide substrate, and a fluorine substrate. A thickness of the insulating substrate may be 500 μm or less, 250 μm or less, 200 μm or less, or 150 μm or less, for example. A thickness of the insulating substrate may be 50 μm or more, for example.

The substrate may include a coating covering at least one principal surface of the insulating substrate. The coating film may contain at least one of a cured product of a curable resin (such as an epoxy resin) and a thermoplastic resin (such as a fluororesin). As the epoxy resin, those exemplified above can be used. Examples of the fluororesin include polytetrafluoroethylene, perfluoroalkoxy alkane, perfluoroethylene propene copolymer, perfluoroethylene propene copolymer, polyvinylidene fluoride, and vinylidene fluoride copolymer.

The resin material forming the coating may be a thermoplastic resin or a curable resin. The resin material (resin composition) forming the coating film may contain additive agents such as a catalyst, a curing agent, a crosslinking agent, a polymerization initiator, and a curing accelerator. The coating is formed by applying a coating agent containing a resin material to the principal surface of the insulating substrate and drying or heating the coating agent. The coating agent may contain a solvent. Examples of the solvent include water and an organic solvent.

The coating may contain a filler. Examples of the filler include insulating particles and insulating fibers. Examples of the insulating material constituting the filler include an insulating compound (such as an oxide) such as silica and alumina, glass, and a mineral material (such as talc, mica, or clay).

A thickness of the coating may be 0.3 μm or more, 1 μm or more, 3 μm or more, 10 μm or more, or 30 μm or more, for example. A thickness of the coating film may be 100 μm or less, for example.

### (Exterior Body)

The capacitor element (or a plurality of capacitor elements stacked) is sealed by being covered with the exterior body. The capacitor element may be sealed exposing an end surface of at least one of the anode part and the cathode part from the outer surface of the exterior body. After the sealing, the exterior body may be partially removed to form an outer surface, and an end surface of at least one of the anode part and the cathode part may be exposed from the outer surface. The lead electrically connected to one of the anode part and the cathode part has the other end sealed with the exterior body while being drawn out from the exterior body, and the other end of the lead may be connected to the external electrode. Alternatively, an external lead terminal in the shape of a plate bent into a predetermined shape may be bonded to a surface of the cathode part exposed in the capacitor element (or a lowermost layer or an uppermost layer of the plurality of capacitor elements stacked) with a conductive paste or the like interposed between the external lead terminal and the capacitor element to electrically connect the capacitor element and the lead terminal.

The exterior body preferably contains a cured product of a curable resin composition, and may contain a thermoplastic resin or a composition containing the thermoplastic resin, for example.

The exterior body may be formed by using a molding technique such as injection molding, for example. The exterior body may be formed by using a predetermined mold and filling a predetermined part of the predetermined mold with a curable resin composition or a thermoplastic resin (composition) to cover the capacitor element supported by the substrate, for example.

The curable resin composition may contain not only the curable resin, but also at least one kind selected from a filler, a curing agent, a polymerization initiator, a catalyst, and the like. Examples of the curable resin include a thermosetting resin. The curing agent, the polymerization initiator, the catalyst, and the like are selected as appropriate, depending on the kind of the curable resin.

Examples of the curable resin include an epoxy resin, a phenol resin, a urea resin, polyimide, polyamideimide, polyurethane, diallyl phthalate, and unsaturated polyester. Examples of the thermoplastic resin include polyphenylene sulfide (PPS) and polybutylene terephthalate (PBT). Alternatively, a thermoplastic resin composition containing a thermoplastic resin and a filler may be used.

From the viewpoint of enhancing strength and the like of the exterior body, the exterior body preferably contains a filler. The filler may be selected from among the fillers described for the coating. The exterior body may contain one kind of filler, or may contain two or more kinds of filler in combination.

### (Contact Layer)

At least one of the anode part and the cathode part may have an end surface exposed from the exterior body, the end surface being connected to the external electrode with a contact layer interposed therebetween. The contact layer may be composed of an electroless Ni plating layer, or may be composed of an electroless Ni plating layer and an electroless Ag plating layer covering the electroless Ni plating layer, for example. When the contact layer is provided, the contact layer enables electrical connection between the end surface of the anode part or the cathode part and the external electrode to be further ensured, and thus being advantageous in enhancing reliability of the solid electrolytic capacitor.

The contact layer may be selectively formed covering only the end surface of the anode part or the cathode part, the end surface being exposed from the exterior body, while covering the surface of the exterior body as little as possible. Prior to formation of the electroless Ni plating layer, zincate treatment may be performed to form the electroless Ni plating layer selectively on the end surface of the anode part or the cathode part.

### (External Electrode)

The external electrode usually includes a first external electrode connected to the cathode part and a second external electrode connected to the anode part. When the anode part includes the anode body including the dielectric layer, the anode body (second part) may have a second end surface exposed from the exterior body, and the second end surface may be electrically connected to the second external electrode. Each external electrode may include a metal layer. The metal layer is a plating layer, for example. The metal layer contains at least one kind selected from the group consisting of nickel (Ni), copper (Cu), zinc (Zn), tin (Sn), silver (Ag), and gold (Au), for example. To form the metal layer, a film forming technique, such as an electrolytic plating method, an electroless plating method, a sputtering method, a vacuum vapor deposition method, a chemical vapor deposition (CVD) method, a cold spraying method, or a thermal spraying method, may be used, for example.

Each external electrode may include a stacked structure of a Ni layer and a tin layer, for example. Each external electrode has an outer surface that is preferably made of a metal having excellent wettability with the solder. Examples of such a metal include Sn, Au, Ag, and Pd.

Each external electrode may include a stacked structure of a conductive paste layer and a plating layer, for example. From the viewpoint of excellent wettability with solder, a plating layer (such as an Ni/Sn plating layer) having the above stacked structure of the Ni layer and the tin layer may be used as the plating layer.

### (Conductive Paste Layer)

The conductive paste layer may be formed covering the end surface of at least one of the anode part and the cathode part of the capacitor element or the plurality of capacitor elements. At this time, the conductive paste layer may be formed covering the end surface with the contact layer interposed therebetween. Alternatively, the conductive paste layer may be formed covering not only the end surface of the anode part or the cathode part but also the surface (side surface or the like) of the exterior body from which the end surface is exposed. Hence, the anode part or the cathode part of the capacitor element is electrically connected to the conductive paste layer.

The conductive paste layer can be formed by applying a conductive paste containing conductive particles and a resin material to the surface of the exterior body where the end surface of the anode part or the cathode part is exposed, and drying the conductive paste. Thus, the conductive paste layer can be referred to also as a conductive resin layer containing conductive particles. The resin material is suitable for adhesion between the exterior body and the contact layer, and can increase bonding strength by chemical bonding (such as hydrogen bonding). As the conductive particles, metal particles such as those of silver or copper, or particles of a conductive inorganic material such as those of carbon may be used, for example.

The conductive paste layer may be provided covering not only the surface (such as the side surface) of the exterior body where the end surface of the anode part or the cathode part of the capacitor element is exposed, but also a part of a surface (such as a top or bottom surface) intersecting the surface. When the surface of the substrate constitutes a part of the outer surface of the capacitor element, the surface of the substrate may be partially covered.

When a multilayer substrate including an insulating substrate is used as the insulating substrate, the external electrode (such as the first external electrode electrically connected to the cathode part) may be formed in advance on the multilayer substrate on a side opposite to a side on which the element stack of the multilayer substrate is mounted. When being mounted, the external electrode (such as the first external electrode) can be electrically connected to the anode part or the cathode part (usually, the cathode part) of the capacitor element through the wiring pattern formed on the multilayer substrate and the through-hole through which the wiring pattern on the front surface and the wiring pattern on the back surface are connected to each other. This configuration allows the first external electrode to be electrically connected to the cathode part of each capacitor element using the substrate. The first external electrode (cathode) can be optionally disposed in a central region of a bottom surface of the electrolytic capacitor depending on the wiring pattern on the back surface. For example, the first external electrode may be disposed close to the second external electrode.

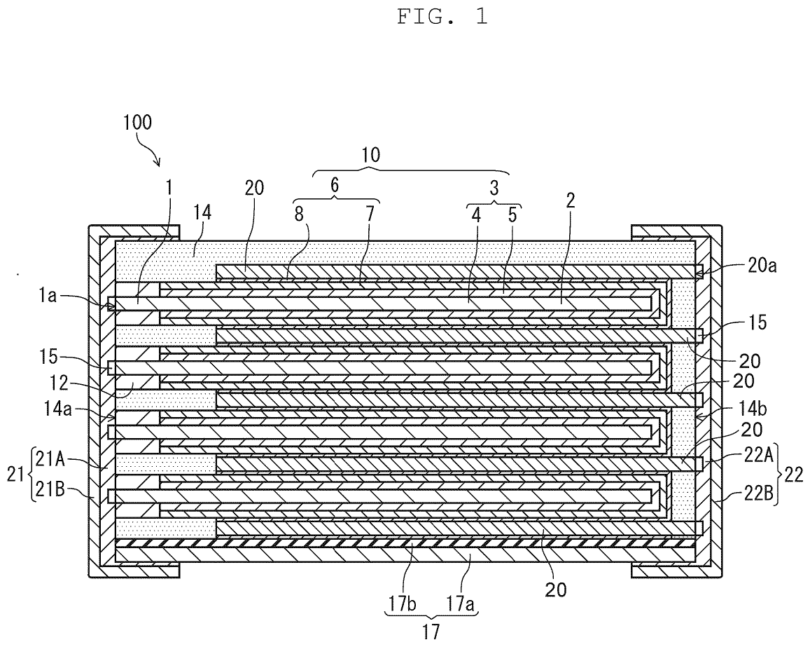

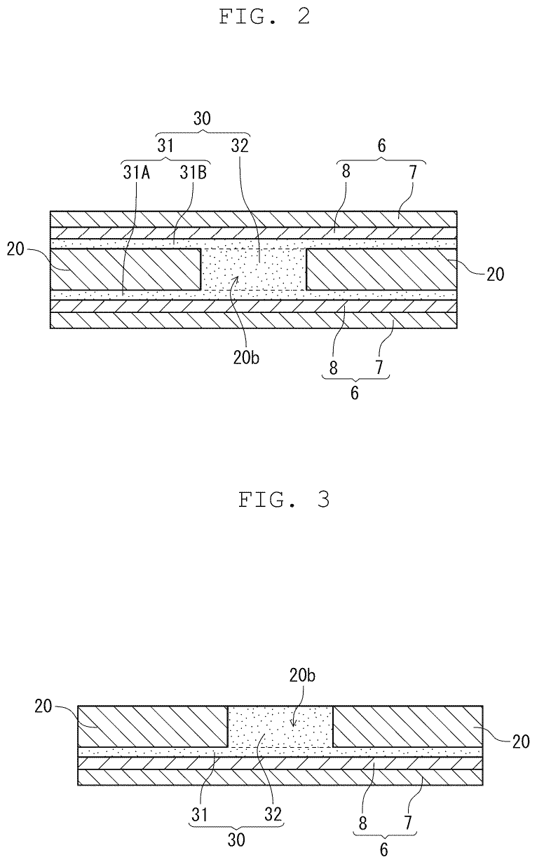

FIG. 1 is a sectional view schematically illustrating an example of an electrolytic capacitor according to one exemplary embodiment of the present disclosure. FIG. 2 is an enlarged schematic sectional view illustrating a main part of the electrolytic capacitor illustrated in FIG. 1, the main part being a vicinity of a metal foil disposed between capacitor elements adjacent to each other in an element stack. FIG. 3 is an enlarged schematic sectional view illustrating a main part of the electrolytic capacitor illustrated in FIG. 1, the main part being a vicinity of a metal foil disposed at an end part of the element stack. Although electrolytic capacitor 100 in FIG. 1 includes through-hole 20b and conductive adhesive layer 30 illustrated in FIGS. 2 and 3, through-hole 20b and conductive adhesive layer 30 are not illustrated in FIG. 1 for convenience.

As illustrated in FIG. 1, electrolytic capacitor 100 includes a plurality of capacitor elements 10 stacked, exterior body 14 that seals capacitor elements 10, first external electrode 22, and second external electrode 21. The illustrated example shows that the plurality of capacitor elements 10 stacked is supported by substrate 17. Substrate 17 includes insulating substrate 17a and coating 17b covering one principal surface of insulating substrate 17a.

Each capacitor element 10 includes anode body 3 constituting an anode part, and cathode part 6. Anode body 3 is anode foil, for example. Anode body 3 includes core part 4 and porous part 5 formed in a surface of core part 4 (a surface layer of anode body 3). A dielectric layer (not illustrated) is formed on a surface of at least part of porous part 5. Cathode part 6 is provided covering at least part of the dielectric layer. Cathode part 6 includes solid electrolyte layer 7 and a cathode lead-out layer.

Capacitor element 10 has one end part (first end part) from which anode body 3 is exposed without being covered with cathode part 6. Capacitor element 10 has the other end part (second end part) covered with cathode part 6. Anode body 3 includes a part covered with cathode part 6 (especially, solid electrolyte layer 7) that is referred to as second part 2, and a part other than second part 2 is referred to as first part 1. First part 1 is not covered with cathode part 6 of anode body 3. First part 1 has an end part serving as the first end, and second part 2 has an end part serving as the second end part.

The illustrated example shows that second part 2 includes core 4 and porous part 5 formed in a surface of core 4. First part 1 may have a surface with or without porous part 5. The dielectric layer is formed along a surface of porous part 5 formed at least in second part 2. At least a part of the dielectric layer is provided covering an inner wall surface of a hole of porous part 5 and formed along the inner wall surface.

Cathode part 6 includes solid electrolyte layer 7 covering at least a part of the dielectric layer, and a cathode lead-out layer covering at least a part of solid electrolyte layer 7. The dielectric layer has a surface in an uneven shape corresponding to a shape of a surface of anode body 3. Solid electrolyte layer 7 is formed filling such unevenness of the dielectric layer, for example. The cathode lead-out layer includes carbon layer 8 covering at least a part of solid electrolyte layer 7.

Electrolytic capacitor 10 includes metal foil 20 electrically connected to cathode part 6 (FIGS. 2 and 3). Metal foil 20 includes at least one through-hole 20b passing through the metal foil in its thickness direction. By conductive adhesive layer 30, metal foil 20 is into contact with the cathode lead-out layer (carbon layer 8) of cathode part 6. Conductive adhesive layer 30 includes first layer 31 disposed between cathode part 6 and a principal surface of metal foil 20, and second layer 32 filled in through-hole 20b. First layer 31 is formed on the principal surface of metal foil 20 and second layer 32 filled in through-hole 20b. First layer 31 is integrated with second layer 32.

Metal foil 20 illustrated in FIG. 2 is disposed between capacitor elements 10 adjacent to each other in the stacking direction. In this configuration, first layer 31 is formed on each of both principal surfaces of metal foil 20. That is, first layer 31 includes 1A-th layer 31A disposed between cathode part 6 of one of capacitor elements 10 adjacent to each other and one principal surface of metal foil 20, and 1B-th layer 31B disposed between cathode part 6 of the other of capacitor elements 10 adjacent to each other and the other principal surface of metal foil 20. 1A-th layer 31A and 1B-th layer 31B are integrated with second layer 32. 1A-th layer 31A and 1B-th layer 31B are integrated with second layer 32 interposed therebetween.

Metal foil 20 illustrated in FIG. 3 is disposed on capacitor element 10 at an end part in the stacking direction. In this configuration, first layer 31 is formed on one principal surface (close to capacitor element 10) of metal foil 20. First layer 31 and second layer 32 are integrated with each other.

Insulating separation layer (or insulating member) 12 may be formed covering a surface of anode body 3 at least in a part adjacent to cathode part 6 in a region of anode body 3, the region being without facing cathode part 6. This configuration restricts contact between cathode part 6 and an exposed part (first part 1) of anode body 3. Separation layer 12 is an insulating resin layer, for example.

Exterior body 14 has a substantially rectangular parallelepiped outer shape, and electrolytic capacitor 100 also has a substantially rectangular parallelepiped outer shape. The illustrated example shows that exterior body 14 has first outer surface 14a and second outer surface 14b opposite to first outer surface 14a. Anode body 3 being the anode part of each capacitor element 10 includes the first end part with end surface 1a exposed at first outer surface 14a. Metal foil 20 has end surface 20a exposed from the exterior body at second outer surface 14b.

End surface 20a exposed from exterior body 14 of each metal foil 20 and second outer surface 14b are covered with first external electrode 22. End surface 20a of metal foil 20 is provided with contact layer 15 covering end surface 20a. First external electrode 22 is electrically connected to end surface 20a of metal foil 20 with contact layer 15 interposed therebetween.

Electrolytic capacitor 100 includes second external electrode 21 covering end surface 1a of the first end part of each of the plurality of anode bodies 3, the end surface being exposed from exterior body 14, and first outer surface 14a. End surface 1a of each anode body 3 is provided with contact layer 15 covering end surface 1a. The illustrated example shows that an end surface of separation layer 12 is also exposed from first outer surface 14a of exterior body 14, and this exposed end surface is also covered with second external electrode 21. Second external electrode 21 is electrically connected to end surface 1a of anode body 3 with contact layer 15 interposed therebetween.

Second external electrode 21 includes conductive paste layer 21A such as a silver paste layer, and Ni/Sn plating layer 21B covering conductive paste layer 21A, for example. Similarly, first external electrode 22 includes conductive paste layer 22A such as a silver paste layer, and Ni/Sn plating layer 22B covering conductive paste layer 22A, for example.

Second external electrode 21 is provided covering not only the whole of first outer surface 14a of exterior body 14, but also a part of each of a third outer surface perpendicular to first outer surface 14a and substrate 17, the part being close to first outer surface 14a. Similarly, first external electrode 22 is provided covering not only the whole of second outer surface 14b, but also a part of each of third outer surface 14c perpendicular to second outer surface 14b and substrate 17, the part being close to second outer surface 14b. The configuration described above enables both of adhesion between second external electrode 21 and first outer surface 14a, and adhesion between first external electrode 22 and second outer surface 14b, to be further enhanced. First external electrode 22 and second external electrode 21 covering a part of substrate 17 are each exposed on a bottom surface of electrolytic capacitor 100. These exposed parts each constitute corresponding one of an anode terminal and a cathode terminal of electrolytic capacitor 100.

### <<Supplementary Note>>

The description above of the exemplary embodiment discloses techniques below.

### (Technique 1)

An electrolytic capacitor includes:
a capacitor element including an anode part and a cathode part;
an exterior body sealing the capacitor element;
a metal foil electrically connected to the cathode part;
a first external electrode electrically connected to the metal foil; and
a conductive adhesive layer.

The metal foil includes a through-hole passing through the metal foil in a thickness direction,
the conductive adhesive layer includes a first layer and a second layer, the first layer being disposed between the cathode part and a first principal surface of the metal foil, the second layer being filled in the through-hole,
the first layer and the second layer are integrated with each other,
the metal foil includes a first end surface exposed from the exterior body, and
the first end surface is electrically connected to the first external electrode.

### (Technique 2)

The electrolytic capacitor described in Technique 1, including an element stack including a plurality of capacitor elements stacked on each other, the plurality of capacitor elements including the capacitor element.

### (Technique 3)

The electrolytic capacitor described in Technique 2, in which:
the metal foil is disposed between two capacitor elements adjacent to each other among the plurality of capacitor elements in the element stack,
the first layer includes a 1A-th layer and a 1B-th layer, the 1A-th layer being disposed between the cathode part of one of the two capacitor elements and the first principal surface of the metal foil, the 1B-th layer being disposed between the cathode part of another of the two capacitor elements and a second principal surface of the metal foil, the second principal surface being opposite to the first principal surface, and
the 1A-th layer and the 1B-th layer are integrated with the second layer.

### (Technique 4)

The electrolytic capacitor described in any one of Techniques 1 to 3, in which:
the cathode part includes a solid electrolyte layer covering at least a part of a surface of a dielectric layer, and a cathode lead-out layer covering the solid electrolyte layer, and
the conductive adhesive layer is disposed between the cathode lead-out layer and the metal foil.

### (Technique 5)

The electrolytic capacitor described in Technique 4, in which:
the cathode lead-out layer includes a carbon layer covering a surface of the solid electrolyte layer, and
the conductive adhesive layer is disposed between the carbon layer and the metal foil.

### (Technique 6)

The electrolytic capacitor described in Technique 4, in which:
the cathode lead-out layer includes a carbon layer covering a surface of the solid electrolyte layer and a metal-containing layer covering a surface of the carbon layer,
the metal-containing layer contains metal particles and a resin, and
the conductive adhesive layer is disposed between the metal-containing layer and the metal foil.

### (Technique 7)

The electrolytic capacitor described in any one of Techniques 1 to 6, further including a second external electrode electrically connected to the anode part.

### (Technique 8)

The electrolytic capacitor described in Technique 7, in which:
the anode part includes an anode body including a dielectric layer disposed on a surface of the anode body,
the anode body includes a second end surface exposed from the exterior body, and
the second end surface is electrically connected to the second external electrode.

### (Technique 9)

The electrolytic capacitor described in any one of Techniques 1 to 8, in which, when the metal foil is viewed in a normal direction of the first principal surface of the metal foil, a proportion of an area of the through-hole in a region of the metal foil that is in contact with the cathode part ranges from 0.04% to 15%, inclusive.

### (Technique 10)

The electrolytic capacitor described in any one of Techniques 1 to 9, in which, when the metal foil is viewed in a normal direction of the first principal surface of the metal foil, the through-hole has a circular shape, an elliptical shape, a polygonal shape, or a linear shape.

### (Technique 11)

The electrolytic capacitor described in any one of Techniques 1 to 10, in which a plurality of through-holes including the through-hole are regularly provided.

### (Technique 12)

The electrolytic capacitor described in Technique 11, in which the plurality of through-holes are arranged in a lattice pattern.

### (Technique 13)

The electrolytic capacitor described in any one of Techniques 1 to 12, in which the metal foil contains at least one selected from the group consisting of aluminum, an aluminum alloy, copper, and a copper alloy.

### (Technique 14)

The electrolytic capacitor described in any one of Techniques 1 to 13, in which:
the metal foil includes a coating layer disposed on the principal surface of the metal foil, and
the coating layer includes at least one layer selected from the group consisting of a titanium layer, a nickel layer, a titanium nitride layer, a titanium carbide layer, a titanium carbonitride layer, a titanium oxide layer, and a carbon layer.

### (Technique 15)

The electrolytic capacitor described in Technique 2, further including a substrate that supports the element stack.

### (Technique 16)

The electrolytic capacitor described in any one of Techniques 1 to 15, in which:
the conductive adhesive layer contains conductive particles and a resin, and
the conductive particles include at least one selected from the group consisting of carbon particles and metal particles.

### EXAMPLES

Although the present disclosure will be specifically described below based on Examples and Comparative Examples, the present disclosure is not limited to Examples below.

### <<Electrolytic Capacitors A1 to A8 and B1>>

Solid electrolytic capacitors each including a plurality of capacitor elements 10 stacked as illustrated in FIG. 1 were produced in the following manner, and characteristics of the solid electrolytic capacitors were evaluated.

### (Production of Capacitor Element 10)

Both surfaces of aluminum foil (thickness: 100 μm) were etched to produce anode body 3. Anode body 3 was subjected to an anodizing treatment to form a dielectric layer (aluminum oxide layer) on a surface of second part 2. After separation layer 12 was formed on first end part 1 of anode body 3, solid electrolyte layer 7 containing a conductive polymer was formed covering second part 2 of anode body 3 that includes the dielectric layer on the surface.

Anode body 3 provided with the dielectric layer and the solid electrolyte layer on the surface was immersed in a dispersion liquid in which graphite particles were dispersed in water, and was taken out from the dispersion liquid. After that, anode body 3 was heated and dried to form carbon layer 8 at least on a surface of solid electrolyte layer 7. Consequently, a cathode lead-out layer including carbon layer 8 was formed on the surface of solid electrolyte layer 7 to obtain capacitor element 10.

### (Production of Metal Foil 20)

As metal foil 20 used for producing an element stack, an aluminum foil having a thickness of 20 μm was prepared. Through-holes 20b in shapes and number shown in Table 1 (FIGS. 4 to 7) were formed on metal foil 20 at predetermined positions. The sizes of the through-holes were adjusted to set an area proportion of the through-holes in the metal foil (region to be brought into contact with a cathode part: shaded part in FIGS. 4 to 7) to have each value shown in Table 1. A through-hole in a circular shape was provided by punching. A through hole in a linear shape was formed using a cutter knife.

### (Stacking of Capacitor Elements 10)

A plurality of capacitor elements 10 was stacked to overlap first parts 1 with each other, thereby producing an element stack. At this time, metal foil 20 (aluminum foil with a thickness of 20 μm) was disposed between capacitor elements 10 adjacent to each other. Then, metal foil 20 was also disposed on capacitor element 10 at an end part in a stacking direction (an end part opposite to substrate 17).

Metal foil 20 was brought into contact with capacitor element 10 (carbon layer 8) using a conductive adhesive. As the conductive adhesive, a conductive paste containing conductive carbon particles and a resin material was used. Specifically, the conductive adhesive was applied to the principal surface of the metal foil and filled in the through-hole of the metal foil to form conductive adhesive layer 30. As conductive adhesive layer 30, first layer 31 and second layer 32 were integrally formed. First layer 31 was formed between the cathode lead-out layer of capacitor element 10 and the principal surface of metal foil 20. The second layer was formed in through-hole 20b. The second layer was filled in through-hole 20b at a filling ratio of 75% or more.

### (Placement of Substrate 17)

The element stack was mounted on substrate 17 using an epoxy-based adhesive. Substrate 17 is constituted by only insulating substrate 17a. As insulating substrate 17a, a glass epoxy substrate having an average thickness of 100 μm, which has been heated and dried, was used.

(Sealing with Exterior Body 14)

Exterior body 14 made of an insulating resin was formed around capacitor element 10 by molding.

Exterior body 14 was cut to remove parts close to the side surfaces by dicing to form first outer surface 14a and second outer surface 14b. At this time, exterior body 14 was cut to expose end surface 1a of anode body 3 of each capacitor element 10 from first outer surface 14a, and to expose end surface 20a of metal foil 20 from second outer surface 14b. Consequently, a precursor was obtained in a state where end surface 1a of anode body 3 was exposed from first outer surface 14a, and end surface 20a of metal foil 20 that constitutes cathode part 6 was exposed from second outer surface 14b. First outer surface 14a and second outer surface 14b of exterior body 14, and the end surface of separation layer 12 exposed from first outer surface 14a were subjected to cleaning treatment and hydrophilization treatment.

### (Formation of Contact Layer 15)

An electroless Ni plating layer was formed to cover end surface 1a of anode body 3, which was exposed from first outer surface 14a, for the precursor obtained as described above, and then an electroless Ag plating layer was formed on the electroless Ni plating layer. Consequently, contact layer 15 including the electroless Ni plating layer and the electroless Ag plating layer was formed. As the same manner with the above, contact layer 15 covering end surface 20a of metal foil 20, which was exposed from second outer surface 14b, was formed.

### (Formation of First External Electrode 22 and Second External Electrode 21)

Each of first external electrode 22 and second external electrode 21 was formed to cover contact layer 15, which were formed as described above, and corresponding one of first outer surface 14a or second outer surface 14b.

More specifically, the conductive paste containing silver particles and a resin was applied to contact layer 15 and the outer surface of the exterior body, and then was heated and dried to form each of conductive paste layers 21A and 22A. Subsequently, an electrolytic Ni plating layer and an electrolytic Sn plating layer were formed to cover each of conductive paste layers 21A and 22A. Consequently, each of Ni/Sn plating layers 21B and 22B was formed. A surface of the plating layer was washed with water and dried to obtain an electrolytic capacitor including first external electrode 22 and second external electrode 21.

### <<Electrolytic Capacitor B1>>

Except that the metal foil was not provided with the through-hole, electrolytic capacitor B1 was obtained as the same manner with electrolytic capacitor A1.

The electrolytic capacitors obtained were subjected to evaluations 1 and 2 below.

### [Evaluation 1: Initial Capacitance, ESR, Height Dimension]

For each of the electrolytic capacitors, initial capacitance (μF) at a frequency of 120 Hz and initial ESR (mΩ) at a frequency of 100 kHz were measured in an environment of 20° C. using an LCR meter for 4-terminal measurement.

Additionally, an initial height dimension (mm) of each of the electrolytic capacitors was measured. Each of the electrolytic capacitors had a height dimension defined as a height dimension in the stacking direction of the element stack (length in the stacking direction from an upper surface where exterior body 14 is exposed to a lower surface where substrate 17 is exposed illustrated in FIG. 1).

For measurement of initial capacitance, ESR, and height dimension, ten electrolytic capacitors were tested. For each of the initial capacitance and the ESR, a standard deviation of ten measured values was determined. The ESR and the height dimension were respectively obtained as initial ESR (X0) and height dimension (H0), which were each an average value of ten measured values.

[Evaluation 2: ΔESR and Δ Dimension (Swelling) after Reflow Treatment]

The electrolytic capacitors were allowed to stand in a thermostatic chamber at 155° C. for 24 hours (baking treatment). Next, the electrolytic capacitors were allowed to stand in a thermo-hygrostat at 30° C. and 60% RH for 192 hours (moisture absorption treatment). After that, the electrolytic capacitors were taken out from the thermo-hygrostat, and cooled to 25° C.

Subsequently, the electrolytic capacitors were subjected to reflow treatment in accordance with IPC/JEDEC J-STD-020D. Specifically, the electrolytic capacitors were preheated at a holding temperature of 150° C. to 200° C. and for a holding time of 180 seconds or less. The solid electrolytic capacitors after being preheated were heated at a temperature of 255° C. or higher (maximum temperature: 260° C.) for 30 seconds. At this time, heating at a maximum temperature of 260° C. was performed for 10 seconds or less.

ESR (X1) and height dimension (H1) of each of the electrolytic capacitors after being subjected to the reflow treatment were determined by a method similar to that in Evaluation 1.

Obtained values X0 and X1 were used to determine ΔESR (%) (change ratio in ESR after the reflow treatment) according to Expression (1) below.

$$Δ ESR = ( X 1 - X 0 ) / X 0 \times 100 \qquad ( 1 )$$

Obtained values H0 and H1 were used to determine Δdimension (swelling) (%) (change ratio in height after the reflow treatment) according to Expression (2) below.

$$Δdimension ( swelling ) = ( H 1 - H 0 ) / H 0 \times 100 \qquad ( 2 )$$

Evaluation results are shown in Table 1. Table 1 shows A1 to A8 each indicating Example, and B1 indicating Comparative Example. Table 1 shows standard deviations σ of initial capacitance and initial ESR, the standard deviations each being expressed as a relative value when standard deviation σ of each of initial capacitance and initial ESR of electrolytic capacitor B1 is defined as 100. Table 1 also shows values of ΔESR and Δdimension (swelling) that are each expressed as a relative value when each of ΔESR and Δdimension (swelling) of electrolytic capacitor B1 is defined as 100.

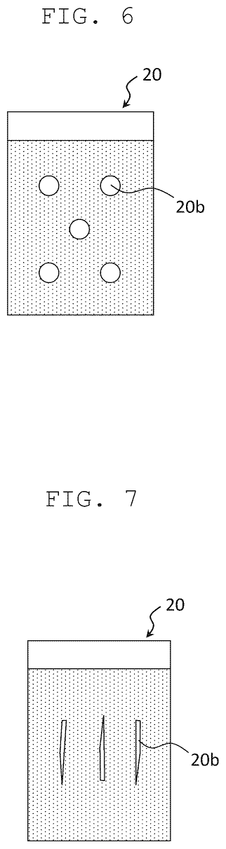

TABLE 1

| | | | | Area proportion (%) | Standard | Standard | ΔESR | Δdimension |
|---|---|---|---|---|---|---|---|---|
| | | | | of through-hole in | deviations | deviations | after | (swelling) |
| | | Through-hole | | metal foil (region to | σ of initial | σ of initial | reflow | after reflow |
| | | provided in metal foil | | be brought into | capacitance | ESR | treatment | treatment |
| Electrolytic | Metal | | Number | contact with cathode | (relative | (relative | (relative | (relative |
| capacitor | foil | Shape | of pieces | part) | value) | value) | value) | value) |
| B1 | — | — | — | — | 100 | 100 | 100 | 100 |
| A1 | FIG. 4 | Circular | 1 | 0.04 | 71.1 | 44.7 | 87.3 | 81.0 |
| A2 | FIG. 5 | Circular | 2 | 0.09 | 79.3 | 53.5 | 98.4 | 90.5 |
| A3 | FIG. 6 | Circular | 5 | 0.22 | 35.2 | 81.6 | 80.6 | 38.1 |
| A4 | FIG. 4 | Circular | 1 | 1.09 | 38.7 | 50.5 | 48.8 | 66.7 |
| A5 | FIG. 4 | Circular | 1 | 4.37 | 17.9 | 40.8 | 99.1 | 81.0 |
| A6 | FIG. 7 | Linear | 3 | 5.01 | 27.9 | 72.6 | 86.4 | 33.3 |
| A7 | FIG. 4 | Circular | 1 | 9.84 | 51.9 | 24.7 | 78.5 | 42.9 |
| A8 | FIG. 4 | Circular | 1 | 17.49 | 33.6 | 124 | 48.4 | 28.6 |

Electrolytic capacitors A1 to A8 each had a smaller standard deviation σ of initial capacitance than electrolytic capacitor B1, and thus were each reduced in variation in the initial capacitance to be improved in reliability. Electrolytic capacitors A1 to A8 were each reduced in ΔESR and Δdimension after the reflow treatment, and thus heat resistance was also improved. In particular, electrolytic capacitors A1 to A7 each having an area proportion of a through-hole in a range from 0.04% to 15%, inclusive, also had small standard deviations of initial ESR, and thus were reduced in variation of the initial ESR to be further improved in reliability.

### <<Electrolytic Capacitors A9 to A12>>

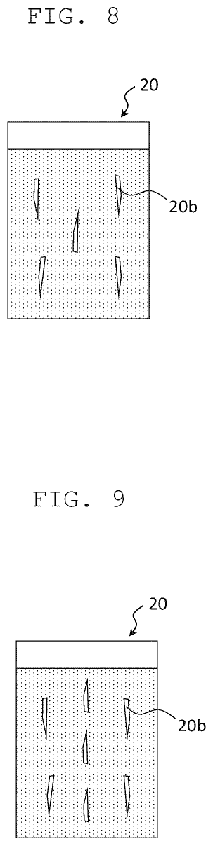

Five, seven, nine, or eleven through-holes each in a linear shape were provided at predetermined positions of the metal foil by using a cutter (FIGS. 8 to 11). The through-holes were adjusted in size to set an area proportion of the through-holes in the metal foil (region to be brought into contact with a cathode part: shaded part in FIGS. 8 to 11) to have each value shown in Table 2. Except for the above, electrolytic capacitors A9 to A12 were prepared as the same manner with electrolytic capacitor A1. As the same manner with the above, values of ΔESR and Δdimension (swelling) after the reflow treatment were determined.

Table 2 shows evaluation results. Table 2 also shows results of electrolytic capacitor B1. Table 2 shows A9 to A12 each indicating Example. Table 2 also shows values of ΔESR and Δdimension (swelling) that are each expressed as a relative value when each of ΔESR and Δdimension (swelling) of electrolytic capacitor B1 is defined as 100.

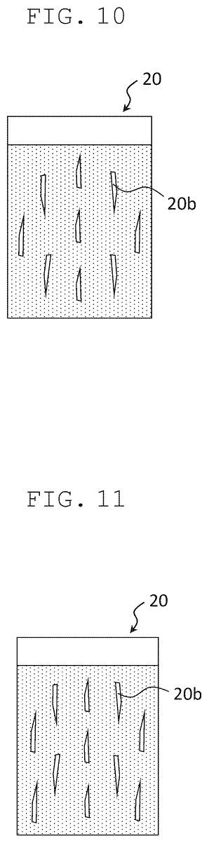

TABLE 2

| | | Through-hole | | Area proportion (%) of | ΔESR after | Δdimension |
|---|---|---|---|---|---|---|
| | | provided in metal foil | | through-hole in metal foil | reflow | (swelling) after |
| Electrolytic | Metal | | Number | (region to be brought into | treatment | reflow treatment |
| capacitor | foil | Shape | of pieces | contact with cathode part) | (relative value) | (relative value) |
| B1 | — | — | — | — | 100 | 100 |
| A9 | FIG. 8 | Linear | 5 | 0.69 | 60.3 | 64.0 |
| A10 | FIG. 9 | Linear | 7 | 0.97 | 74.1 | 93.1 |
| A11 | FIG. 10 | Linear | 9 | 1.24 | 69.4 | 70.0 |
| A12 | FIG. 11 | Linear | 11 | 1.52 | 81.9 | 90.8 |

Electrolytic capacitors A9 to A12 each had ΔESR and Δdimension (swelling) after the reflow treatment that were smaller than those of electrolytic capacitor B1.

Then, adhesion between the metal foil and the capacitor element was evaluated as described below.

### [Evaluation 3: Adhesion Strength Between Metal Foil and Capacitor Element]

As the metal foil, aluminum foil having a thickness of 20 μm was used. The metal foil was provided with one through-hole in a circular shape at near the center of a region to be brought into contact with the cathode part (FIG. 4). The through-hole had a diameter of 0.5 mm, 1 mm, 1.5 mm, or 2 mm. Table 3 shows a value of an area proportion of each through-hole in the metal foil (the region to be brought into contact with the cathode part: shaded part in FIG. 4). A conductive adhesive was applied to one principal surface of the metal foil and filled in the through-hole, and then a capacitor element was disposed on the one principal surface of the metal foil to bring the metal foil into contact with the capacitor element (cathode part). Consequently, the conductive adhesive layer including the first layer and the second layer was formed to produce each of stacked samples a1 to a4. As the capacitor element and the conductive adhesive, the same kinds of capacitor element and conductive adhesive used in electrolytic capacitor A1 were used. Except that the metal foil was not provided with the through-hole (the second layer was not formed), stacked sample b1 was produced as the same manner with stacked sample a1.

Each stacked sample was subjected to a tensile test in which a load was applied until the sample was broken, and a maximum load (referred to below as a “breaking load”) at the time of breaking (when the metal foil was peeled off from the capacitor element) was determined. As a measuring apparatus, a tensile tester in accordance with JIS B 7721 was used. Specifically, a load tester HIT-M and a load cell JLC-M50N manufactured by Japan Instrumentation System Co., Ltd. were used. Ten samples were produced for each of stacked samples a1 to a4 and b1, and an average value of measured values of the ten samples was determined.

Table 3 shows evaluation results. Table 3 shows breaking loads that are each expressed as a relative value when a breaking load of stacked sample b1 is defined as 100.

TABLE 3

| | Area proportion (%) of through- | |
|---|---|---|
| | hole in metal foil (region to be | |
| Stacked | brought into contact with | Breaking load |
| sample | cathode part) | (relative value) |
| b1 | — | 100 |
| a1 | 1.09 | 223.3 |
| a2 | 4.37 | 203.9 |
| a3 | 9.84 | 188.1 |
| a4 | 17.49 | 157.7 |

Stacked samples a1 to a4 each had a larger breaking load than stacked sample b1, and thus were increased in adhesive strength. In particular, stacked samples a1 to a3 each having an area proportion of 15% or less of the through-hole exhibited excellent adhesive strength.

The electrolytic capacitor according to the present disclosure can be used for various applications requiring high reliability.

Although the present invention is described in terms of the preferred exemplary embodiment at present, such disclosure should not be construed in a limiting manner. Various modifications and alterations will undoubtedly become apparent to those skilled in the art belonging to the present invention by reading the above disclosure. Thus, the scope of claims appended is to be construed to cover all variations and modifications without departing from the true spirit and scope of the invention.

What is claimed is:

1. An electrolytic capacitor comprising:
a capacitor element including an anode part and a cathode part;
an exterior body sealing the capacitor element;
a metal foil electrically connected to the cathode part;
a first external electrode electrically connected to the metal foil; and
a conductive adhesive layer,
wherein:
the metal foil includes a through-hole passing through the metal foil in a thickness direction,
the conductive adhesive layer includes a first layer and a second layer, the first layer being disposed between the cathode part and a first principal surface of the metal foil, the second layer being filled in the through-hole,
the first layer and the second layer are integrated with each other,
the metal foil includes a first end surface exposed from the exterior body, and
the first end surface is electrically connected to the first external electrode.

2. The electrolytic capacitor according to claim 1, comprising an element stack including a plurality of capacitor elements stacked on each other, the plurality of capacitor elements including the capacitor element.

3. The electrolytic capacitor according to claim 2, wherein:
the metal foil is disposed between two capacitor elements adjacent to each other among the plurality of capacitor elements in the element stack,
the first layer includes a 1A-th layer and a 1B-th layer, the 1A-th layer being disposed between the cathode part of one of the two capacitor elements and the first principal surface of the metal foil, the 1B-th layer being disposed between the cathode part of another of the two capacitor elements and a second principal surface of the metal foil, the second principal surface being opposite to the first principal surface, and
the 1A-th layer and the 1B-th layer are integrated with the second layer.

4. The electrolytic capacitor according to claim 1, wherein:
the cathode part includes a solid electrolyte layer covering at least a part of a surface of a dielectric layer, and a cathode lead-out layer covering the solid electrolyte layer, and
the conductive adhesive layer is disposed between the cathode lead-out layer and the metal foil.

5. The electrolytic capacitor according to claim 4, wherein:
the cathode lead-out layer includes a carbon layer covering a surface of the solid electrolyte layer, and
the conductive adhesive layer is disposed between the carbon layer and the metal foil.

6. The electrolytic capacitor according to claim 4, wherein:
the cathode lead-out layer includes a carbon layer covering a surface of the solid electrolyte layer and a metal-containing layer covering a surface of the carbon layer,
the metal-containing layer contains metal particles and a resin, and
the conductive adhesive layer is disposed between the metal-containing layer and the metal foil.

7. The electrolytic capacitor according to claim 1, further comprising a second external electrode electrically connected to the anode part.

8. The electrolytic capacitor according to claim 7, wherein:
the anode part includes an anode body including a dielectric layer disposed on a surface of the anode body,
the anode body includes a second end surface exposed from the exterior body, and
the second end surface is electrically connected to the second external electrode.

9. The electrolytic capacitor according to claim 1, wherein, when the metal foil is viewed in a normal direction of the first principal surface of the metal foil, a proportion of an area of the through-hole in a region of the metal foil that is in contact with the cathode part ranges from 0.04% to 15%, inclusive.

10. The electrolytic capacitor according to claim 1, wherein, when the metal foil is viewed in a normal direction of the first principal surface of the metal foil, the through-hole has a circular shape, an elliptical shape, a polygonal shape, or a linear shape.

11. The electrolytic capacitor according to claim 1, wherein a plurality of through-holes including the through-hole are regularly provided.

12. The electrolytic capacitor according to claim 11, wherein the plurality of through-holes are arranged in a lattice pattern.

13. The electrolytic capacitor according to claim 1, wherein the metal foil contains at least one selected from the group consisting of aluminum, an aluminum alloy, copper, and a copper alloy.

14. The electrolytic capacitor according to claim 1, wherein:
the metal foil includes a coating layer disposed on the first principal surface of the metal foil, and
the coating layer includes at least one layer selected from the group consisting of a titanium layer, a nickel layer, a titanium nitride layer, a titanium carbide layer, a titanium carbonitride layer, a titanium oxide layer, and a carbon layer.

15. The electrolytic capacitor according to claim 2, further comprising a substrate that supports the element stack.

16. The electrolytic capacitor according to claim 1, wherein:
the conductive adhesive layer contains conductive particles and a resin, and
the conductive particles include at least one selected from the group consisting of carbon particles and metal particles.
